(19) United States
(12) Patent Application Publication
(10) Pub. No.: US 2011/0192950 A1
(43) Pub. Date: Aug. 11, 2011

(54) CLIP CAPABLE OF ATTRACTING PAINT BRUSH

(76) Inventor: ERIC LIAO, Dali City (TW)

(21) Appl. No.: 12/704,514

(22) Filed: Feb. 11, 2010

(51) Int. Cl. F16M 13/02

(52) U.S. Cl. 248/309.1

(57) ABSTRACT

A clip capable of attracting a paint brush includes a first clipping body, a second clipping body, and an elastic holder is disclosed. One side of each of the first clipping body and the second clipping is a clipping section while the other opposite side thereof is a force-exerting part. The first clipping body further has an accommodating part thereon for receiving the paint brush. The elastic holder has an upper wing and a lower wing respectively extending from the first clipping body and the second clipping body. The bridge section having a rectangular groove is formed at an intersection of the upper wing and the lower wing. A positioning pin is further provided to penetrate through the hinge of the first clipping body and the second clipping body and through the rectangular groove of the elastic holder. Thereby, the first clipping body and the second clipping body and the elastic holder pivotally connect to one another to form the clip.

### BACKGROUND OF THE INVENTION

1. Field of the Invention

This invention relates to a clip, especially to a clip capable of attracting a paint brush.

2. Related Prior Art

Personal style can be expressed by visional representation of selective paint color on interior or exterior walls.

In order to uniformly coat the paint onto the walls, paint roller capable of painting large area of the wall is first used. Then a paint brush replaces to finish the details or fill corners. To achieve a fine painting result, the paint brush is used from the beginning of the painting work.

One of the common problems is when the user needs to stop the painting and places the paint brush with the paint on the ground, dust on the ground will attach to the brush and possibly cause spots which adversely affect the aesthetic effect.

Even if a holding part of the paint brush is hang and therefore avoids the dust from attaching to the paint brush, the liquid paint still drops on the ground.

Some approaches have been proposed to resolve the above problems. For example, in one conventional clip having two L-shaped clipping bodies and a hinge, a twist spring inserts into the hinge. A magnetic element is mounted on one of the L-shaped clipping bodies to attract the paint brush. By means of clipping a paint container by front clipping sections of the L-shaped clipping bodies, brush hair on a front of the paint brush tilts in the paint container so that the paint will not drop on the ground when not for use.

However, the clip having the two L-shaped clipping bodies and the twist spring still has some disadvantages as follows.

1. The twist spring pivotally connects to the two L-shaped clipping bodies. Pins of the twist spring inserting the hinge tends to be fatigue and break due to long-term use of the twist spring.

2. It takes time to complete the assembly of the twist spring to the L-shaped clipping bodies.

Therefore, there is a need to overcome the problems of structural strength and assembly efficiency that encounter in the conventional clip using the twist spring.

### SUMMARY OF THE INVENTION

An object of the invention is to provide a clip having two clipping bodies and an elastic holder integrally formed.

Another object of the invention is to provide a clip which can be assembled fast and have improved service life.

In order to achieve the above and other objectives, the clip of the invention includes a first clipping body, a second clipping body and an elastic holder. A front and a rear of each of the first clipping body and the second clipping body are at an angle of not less than 90° to form a clipping section and a force-exerting part. A hinge is between the corresponding clipping section and the corresponding force-exerting part for each of the first clipping body and the second clipping body. The first clipping body further has an accommodating part thereon for receiving the paint brush.

The elastic holder has an upper wing and a lower wing respectively extending from the first clipping body and the second clipping body. A bridge section is formed at an intersection of the upper wing and the lower wing through a rectangular groove connecting to the hinge. A first location is defined at one end of the rectangular groove and a second location is defined at the other end of the rectangular groove.

A positioning pin penetrates through the hinge of the first clipping body and the second clipping body, and through the rectangular groove of the elastic holder. The positioning pin at the first location presses the upper wing and the lower wing as the first and second clipping bodies move. The bridge section then shifts toward the clipping sections so that the positioning pin against the first location of the rectangular groove turns to urge against the second location of the rectangular groove, thereby the clipping sections separating from each other to be ready for clipping.

The first clipping body and the second clipping body respectively have an opening formed by releasing a mold which is used to define the first inner distance and helps put the integral formation of the clipping bodies, the protruding ears and the elastic holder into practice.

Other objectives, advantages and features of the present invention will become apparent from the following description referring to the attached drawings.

### BRIEF DESCRIPTION OF THE DRAWINGS

The present invention will be described via detailed illustration of the preferred embodiment versus prior art referring to the drawings where:

FIG. 1 is an exploded view of a clip according to the invention.

FIG. 2 is a side view of FIG. 1.

FIG. 3 is a perspective view of a clip in assembly according to the invention.

FIG. 4 is a side view of FIG. 3.

FIG. 5 is a perspective view of a clip with clipping sections being separated from each other according to the invention.

FIG. 6 is a side view of FIG. 5.

FIG. 7 is a schematic view of a clip applied to a paint container according to the invention.

FIG. 8 is a schematic view of a first clipping body having an opening according to the invention.

FIG. 9 is a schematic view of a first clipping body having an opening according to the invention.

### DETAILED DESCRIPTION OF THE INVENTION

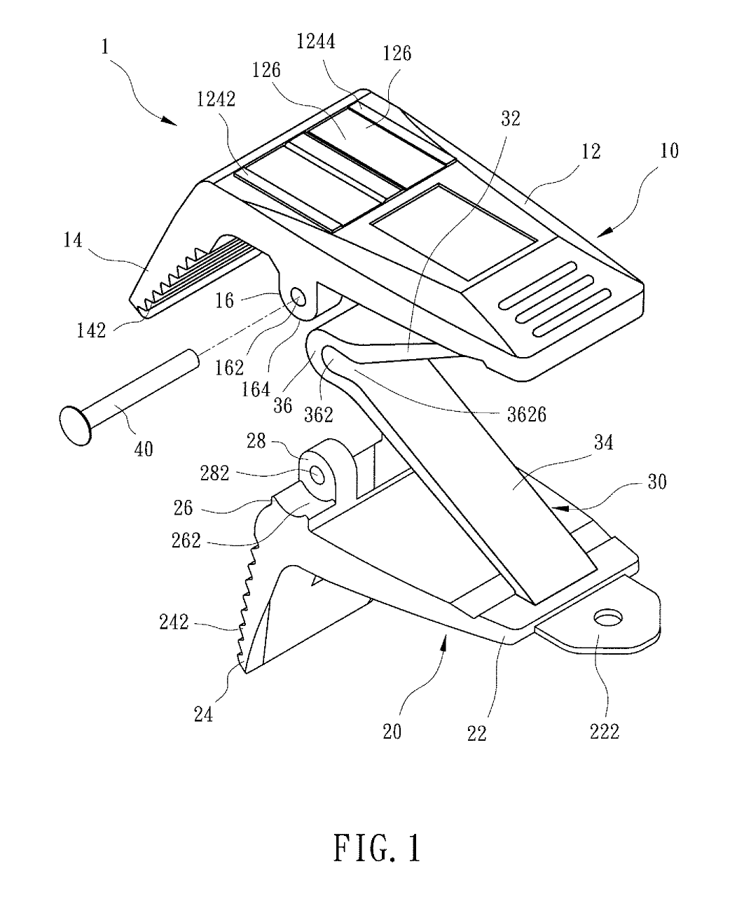

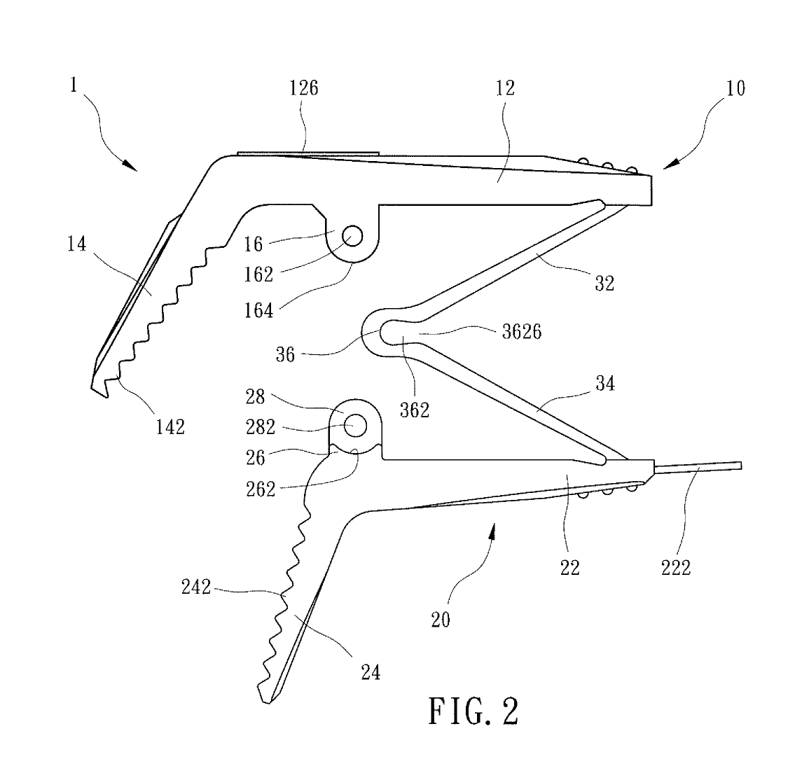

This invention relates to a clip as shown in FIG. 1 through FIG. 3. A clip 1 made of plastic steel consists of a first clipping body 10 and a second clipping body 20, and further an elastic holder 30 which pivotally connects the first clipping body 10 to the second clipping body 20 via a positioning pin 40. Each of the first clipping body 10 and the second clipping body is formed integrally.

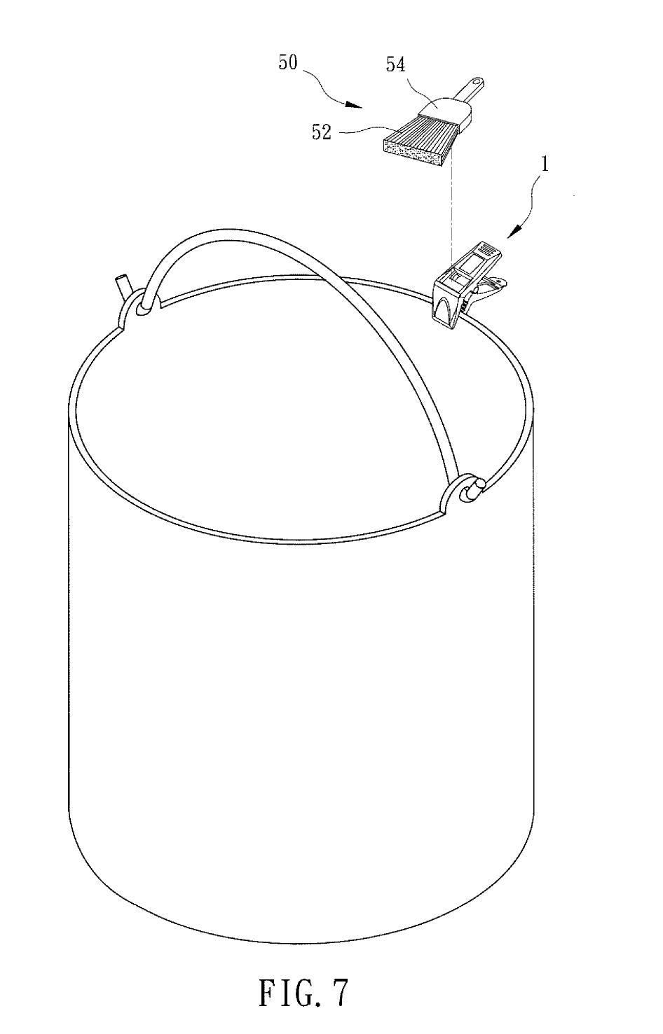

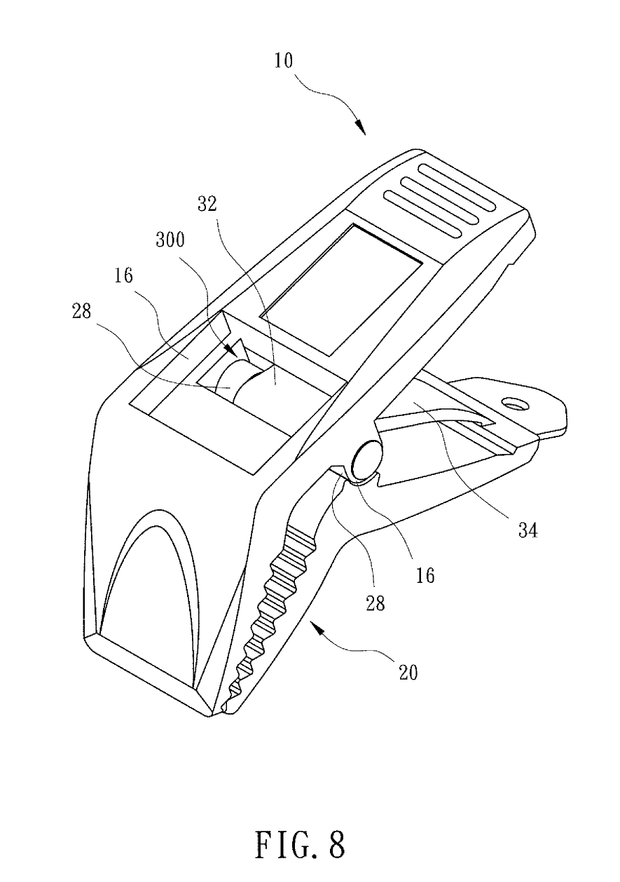

The first clipping body 10 has a force-exerting part 12 a front end of which extends outward at an angle of not less than 90° to form a clipping section 14. On a surface of the force-exerting part 12 adjacent to the clipping section 14 is an accommodating part for receiving a metallic frame 54 of a paint brush 50, as shown in FIG. 7. The accommodating part includes an embedded metal piece and a magnetic element 126, such a magnet, which is received inside the embedded metal piece. The embedded metal piece lies in the lengthwise direction of a holding part, and further has a front wall 1244 and a rear wall 1242 respectively slightly higher than the holding part and magnetic element 126, so that the paint brush attracted by the magnetic element 126 can securely lean against them, providing a further security for the paint brush. On an inner surface of the clipping section 14 are continuously arranged teeth 142 in order to enhance the security of holding. Furthermore, a hinge is formed by extending downward and vertically from a certain position of each side of the force-exerting part 12 of the first clipping body 10. The hinge as shown is a protruding ear 16 having a pivot hole 162. A free end of the protruding ear 16 has a curved surface 164. There is a first distance between the two protruding ears 16. FIG. 8 shows the first clipping body 10 is not equipped with the embedded metal piece and the magnetic element 126 yet. As show, the first clipping body 10 has an opening 300 of diameter equal to the first inner distance. The opening 300 is formed by releasing a mold which is used to define the first inner distance and helps put the integral formation of the clipping body 10, the protruding ears and the elastic holder 30 into practice.

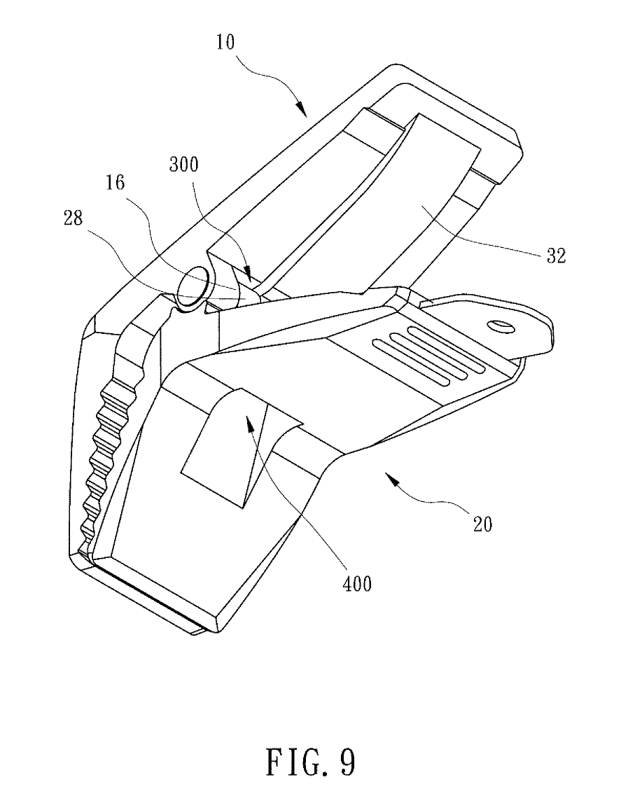

The second clipping body 20 has a force-exerting part 22 which extends outward an angle of not less than 90° to form a tilt clipping section 24. A curved metal sheet 222 extends outward opposite to the clipping section 24. Continuously arranged teeth 242 are on an inner surface of the clipping section 24. Furthermore, each side of the force-exerting part 22 of the second clipping body 20 extends inward a distance equal to the width of the protruding ear 16 of the first clipping body 10 to form a protrusion 26. A recession 262 is formed on each of the protrusion 26 in a manner to support the pivotal connection of the first clipping body 10 to the second clipping body 20 by means of urging the curved surface 164 against the recession 262 when the protruding ears 16 of the first clipping body 10 come to contact the second clipping body 20. A part of each protrusion 26 extends upward and inward to form a hinge to correspond each other. The hinge of the second clipping body 20, like the first clipping body 10, has two protruding ears 28 respectively having pivot holes 282. There is a second inner distance between the two protruding ears 28 for the two protruding ears 28 of the second clipping body 20 to fit within. As shown in FIG. 9, the protruding ears 28 of the second clipping body 20 have an opening 400 of diameter equal to the second inner distance. Like the opening 300, the opening 400 is formed by releasing a mold which is used to define the first inner distance and helps put the integral formation of the clipping body 20, the protruding ears and the elastic holder 30 into practice. The elastic holder 30 has an upper wing 32 and a lower wing 34 respectively extending from the force-exerting parts 12, 22. The upper and lower wings 32, 34 respectively have a [symbol] shape. At an intersection of the upper and lower wings 32, 34, a bridge section 36 received in the second inner distance between the two protruding ears 28 of the second clipping body 20 is formed through a rectangular groove 362. The rectangular groove 362 further communicates with a slit 3626.

The positioning pin 40 penetrates through the pivot holes of the first clipping body 10 and the second clipping body 20, and the rectangular groove 362 of the elastic holder 30, in a manner to unify the first clipping body 10, the second clipping body 20 and the elastic holder 30 to form the clip 1.

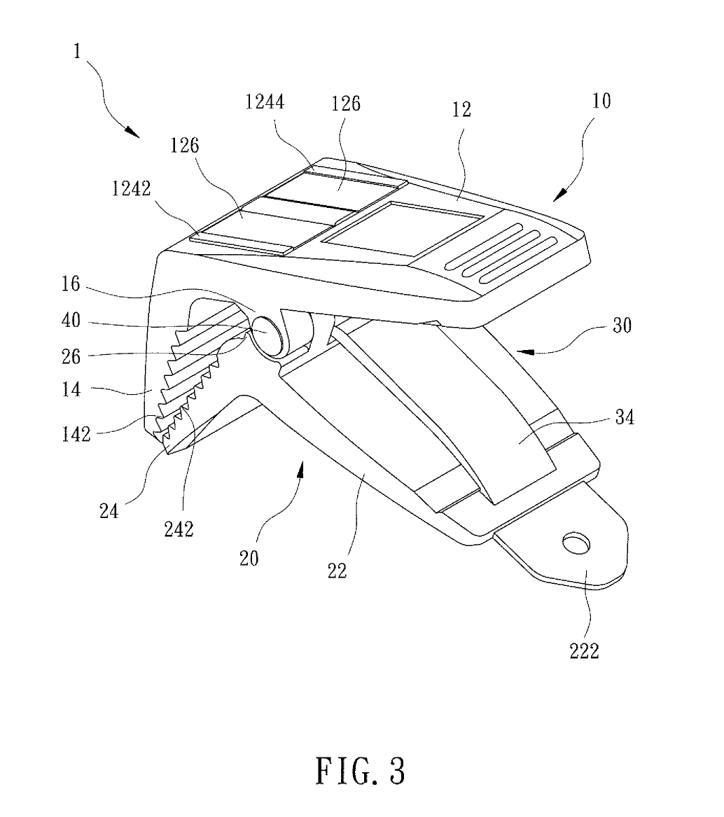

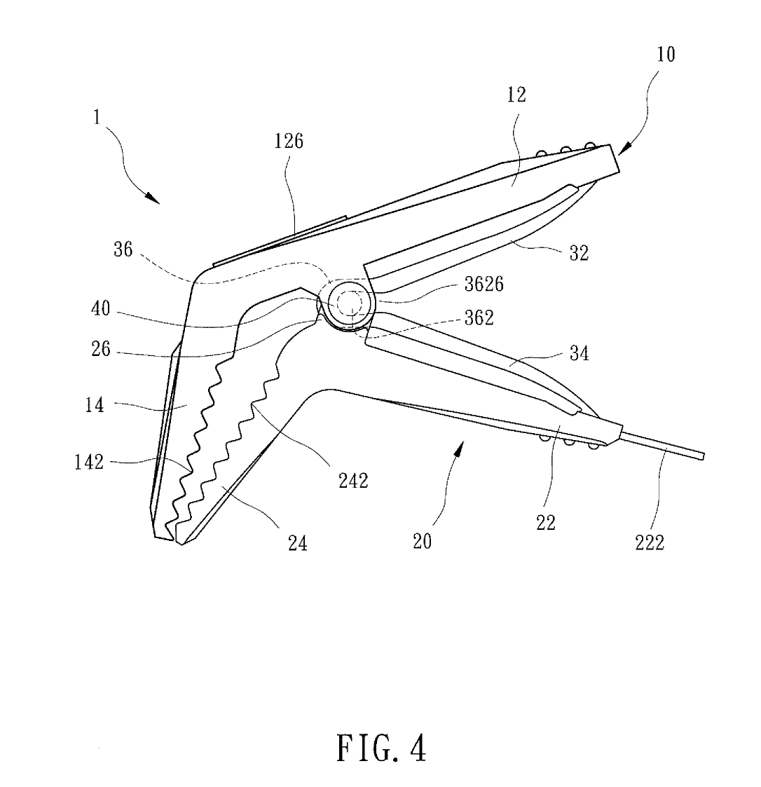

With reference to FIG. 3 and FIG. 4, the force-exerting parts 12, 22 of the first and second clipping bodies 10, 20 normally separate from each other due to the support of the upper and lower wings 32, 34, while the clipping sections 14, 24 are forced to be in contact with each other. At this moment, the location where the positioning pin 40 pivotally connecting the first clipping body 10, the second clipping body 20 and the elastic holder 30 is urged inside the slit 3626 of the rectangular groove 362 is defined as a first location.

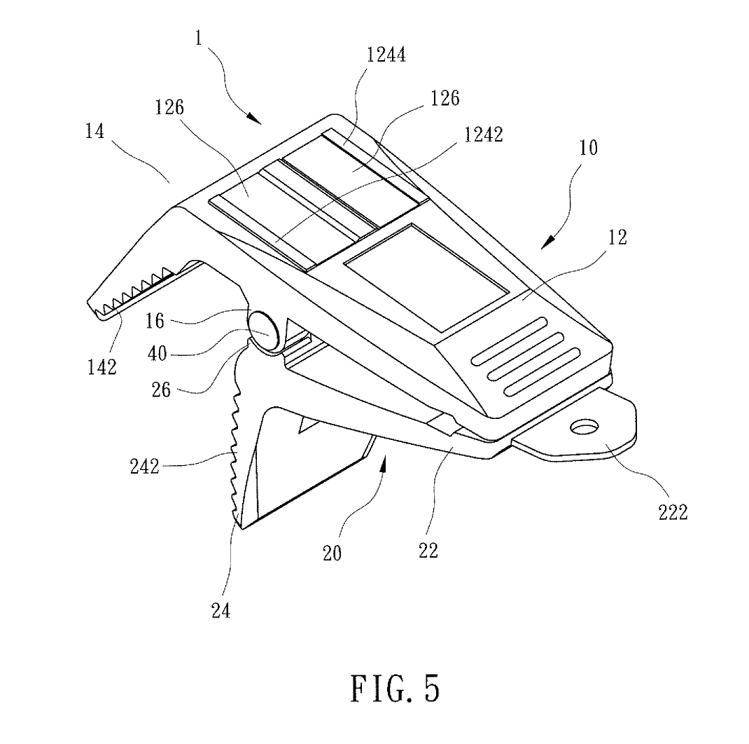

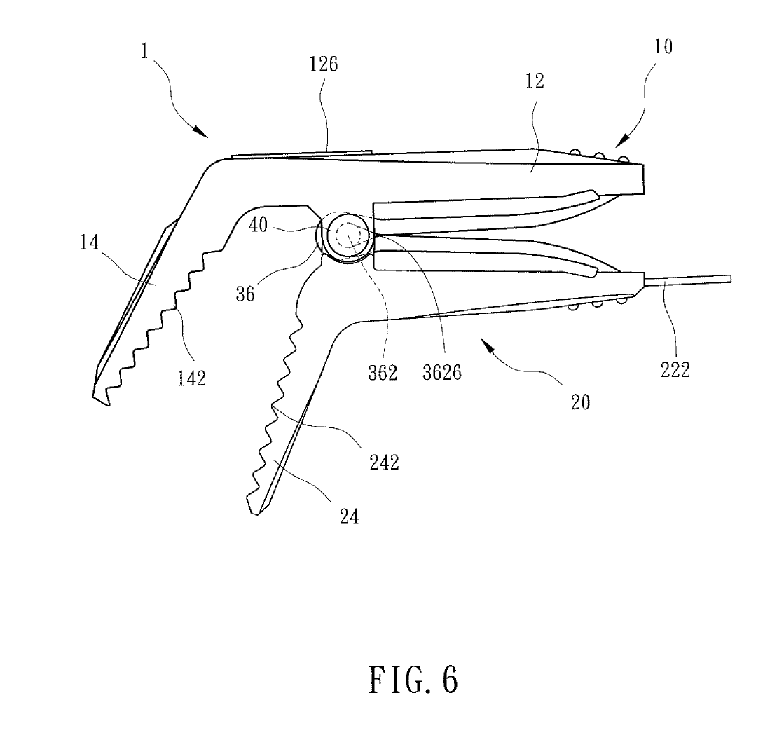

With reference to FIG. 5 and FIG. 6, when the user holds the force-exerting parts 12, 22 and applies a pressing force greater than the supporting force provided by the upper and the lower wings, the first clipping body 10 and the second clipping body 20 are forced to move opposite to each other to press the upper and lower wings, further forcing the bridge section 36 to move toward the first and second clipping sections 14, 24. At this time, the positioning pin 40 at the first location turns to urge against the rectangular groove 362 close to the slit 3626. That location is then defined as a second location. The clipping sections 14, 24 in contact with each other then turn to separate from each other.

With reference to FIG. 7, the clipping sections 14, 24 separating from each other are then fixed at an edge 62 of a paint container 60. The force-exerting part 12 of the first clipping body 10 tilts at an angle relative to the edge 62 of the paint container 60. After the metallic frame 54 of the paint brush 50 comes to contact the magnetic element 126 due to magnetic attraction, the paint on the brush hair 52 of the paint brush 50 won't drop on the ground incidentally even when the painting work stop from time to time because the tip of the brush hair faces toward the inside of the paint container 60, either the brush hair won't attach any dust when the paint brush needs to be placed on the ground.

This invention offers advantages over the prior art are as follows.

Compared to the prior art that uses a spring to hold the two clipping body and have the clipping bodies return to their original position, this invention using the elastic holder overcomes the disadvantages in the prior art such as poor precision of pin insertion of the spring. Furthermore, the integral formation of the clipping bodies advantageously contributes to a simplified assembly.

Compared to the prior art that the spring uses fine pins to insert into the wall of the hinge, the elastic holder of the invention uses the bridge section as a pivot joint, and further uses the rectangular groove for the positioning pin to penetrate. The upper and lower wings of large area contribute to provide elastic support and return to their original position for the clipping bodies. The use of the elastic holder profits in term of reliability compared to the prior art using the spring.

In this invention, the slit is designed to communicate with the rectangular groove of the bridge section, playing a role of resolving the problem of stress concentration of the elastic holder when the force-exerting parts of the two clipping bodies are pressed opposite to each other. Thereby, the service life of the elastic holder can be extended.

In addition to have the paint brush to be powerfully attracted by the magnetic element in this invention, the front wall and the rear wall at the front and the rear of the embedded metal piece are arranged in a manner to be slightly higher than the force-exerting part, so that the metallic frame of the paint brush can lean against and therefore a further security for the paint brush is provided.

In this invention, the pivot hole of the (protruding ear) hinge is formed by releasing a mold which defines the inner distance between the two protruding ears and also helps put the integral formation of the clipping bodies, the protruding ears and the elastic holders into practice.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A clip capable of attracting a paint brush, comprising:
a first clipping body and a second clipping body, one side of each of the first clipping body and the second clipping being a clipping section while the other opposite side thereof being a force-exerting part, wherein a hinge is between the corresponding clipping section and force-exerting part for each of the first clipping body and the second clipping body, and the first clipping body further has an accommodating part thereon for receiving the paint brush;
an elastic holder, having an upper wing and a lower wing respectively extending from the first clipping body and the second clipping body, wherein a bridge section is formed at an intersection of the upper wing and the lower wing through a rectangular groove connecting to the hinge; and
a positioning pin, penetrating through the hinge of the first clipping body and the second clipping body and through the rectangular groove of the elastic holder, so that the first clipping body and the second clipping body and the elastic holder pivotally connect to one another to form the clip.

2. The clip capable of attracting a paint brush of claim 1, wherein the hinge is two protruding ears at opposite sides of each of the first clipping body and the second clipping body, each protruding ear having a pivot hole, an inner distance being between the two protruding ears, and each of the first clipping body and the second clipping body having an opening of diameter equal to the inner distance.

3. The clip capable of attracting a paint brush of claim 2, wherein the two protruding ears of the first clipping body are the sections extending downward from the corresponding side of the first clipping body, the two protruding ears of the second clipping body are the sections extending upward from the corresponding side of the second clipping body, so that the inner distance between the two protruding ears of the first clipping body fits for accommodating the two protruding ears of the second clipping body, and the inner distance between the protruding ears of the second clipping body is for accommodating the bridge section of the elastic holder to allow the positioning pin to penetrate through the first clipping body, the second clipping body and the elastic holder.

4. The clip capable of attracting a paint brush of claim 1, wherein on a surface of the force-exerting part adjacent to the clipping section is an accommodating part including an embedded metal piece and a magnetic element in the embedded metal piece.

5. The clip capable of attracting a paint brush of claim 3, wherein each side of the second clipping body extends inward a distance equal to the width of the protruding ear of the first clipping body to form a protrusion, with a recession being on each of the protrusion in a manner to correspond to the curve surface of the protruding ear.

6. The clip capable of attracting a paint brush of claim 1, wherein the bridge section further has a slit communicating with the rectangular groove.

7. The clip capable of attracting a paint brush of claim 1, wherein a metal sheet extends outward from the force-exerting part of the second clipping body.

8. The clip capable of attracting a paint brush of claim 4, wherein the embedded metal piece at least corresponds to the lengthwise direction of a holding part, and further has a front wall and a rear wall respectively slightly higher than the holding part and magnetic element.

9. The clip capable of attracting a paint brush of claim 1, wherein the positioning pin normally locates at a first location where the first clipping body is in contact with the second clipping body, and moves to a second location where the first clipping body separates from the second clipping body when the force-exerting part is pressed.

10. The clip capable of attracting a paint brush of claim 1, wherein on a surface of each clipping section respectively for the first clipping body and the second clipping body are continuously arranged teeth.
